(19) United States
(12) Patent Application Publication
(10) Pub. No.: US 2001/0045987 A1
(43) Pub. Date: Nov. 29, 2001

(54) SOLID STATE IMAGING DEVICE WITH PIGMENT BASED AND DYE BASED COLOR FILTERS

(76) Inventor: YUKIHIRO SAYAMA, KAGOSHIMA-KEN (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 08/968,648

(22) Filed: Nov. 12, 1997

(30) Foreign Application Priority Data
Nov. 13, 1996 (JP) P08-301420

(51) Int. Cl. H04N 3/14; H04N 9/04

(52) U.S. Cl. 348/273; 348/272

(57) ABSTRACT

A planarization film is formed on sensor portions on a semiconductor substrate, and color filters are formed on the planarization film at positions over the sensor portions. In this case, as color filters of yellow (Y) and cyan (C), dye based color filters are formed in an ordinary dying process of patterning a material and dying the pattern. On the other hand, as color filters of magenta (M) being low in light resistance and thermal resistance, pigment based color filters are formed by a color resist process using a pigment based coloring matter. Thus, there can be realized a solid state imaging device having the color filters allowed to improve characteristics such as light resistance and thermal resistance without changing the spectroscopic characteristic so much.

### BACKGROUND OF THE INVENTION

The present invention relates to a solid state imaging device used for a camera-integrated VTR or the like. In particular, the present invention concerns a solid state imaging device having color filters formed on the front surface side of light receiving elements of the solid state imaging device, wherein those of the color filters, which are of one kind or two kinds of colors, are composed of pigment based color filters and the remaining color filters are composed of dye based color filters, whereby characteristics of the color filters are improved without changing the spectroscopic characteristic.

In recent years, there have been strong demands toward higher resolution and higher performance of solid state imaging devices. The solid state imaging device forms a color image with a high resolution through color filters formed on light receiving elements such as photodiodes. The color filters are composed of patterns, each being colored in magenta, yellow, cyan, or the like, arranged at a high accuracy.

In many cases, color filters of solid state imaging devices have been produced by a dying process. The dying process involves coating the surface of a base with a refined natural organic matter (gelatin, casein, etc.), patterning the film-like organic matter, and dying the pattern. Such a process can produce color filters higher in resolution, permeability, and color tone than those produced by other processes.

The dying process, however, has problems that the degree of dying is difficult to be controlled and characteristics such as light resistance, thermal resistance, and solvent resistance are low. These problems are undesirable when the solid state imaging device having color filters produced by the dying process is used for a monitoring camera device or field camera device because the problems may lead to failures such as sticking.

In view of the foregoing, it has been examined to adopt a color resist process using a pigment based coloring matter for producing color filters of a solid state imaging device in place of the above-described dying process. The color resist process has been disclosed, by the present applicant, in Japanese Patent Laid-open Nos. Hei 6-208021 entitled “Method of Producing Color Filter” and Hei 6-300913 entitled “Color Filter”. In the color resist process, as described in detail in the above documents, particles of a pigment based coloring matter are uniformly dispersed in a photosensitive composition, and the photosensitive composition thus colored is sequentially patterned on a substrate by photolithography, to thus produce color filters.

The color filters using a pigment based coloring matter are good in the above-described characteristics such as light resistance, thermal resistance, and solvent resistance; however, they are not very good in spectroscopic characteristic and also not good in dispersibility of particles of the pigment based coloring matter. Further, the subject of the study and development on the color filters using a pigment based coloring matter has focussed on the color filters of three primary colors, that is, red (R), green (G), and blue (B). In other words, the study has been not made so much on a pigment based material for color filters of complementary colors.

### OBJECT AND SUMMARY OF THE INVENTION

An object of the present invention is to provide a solid state imaging device having color filters which solve both a low light resistance of die based color filters and a low spectroscopic characteristic of pigment based color filters and improve characteristics without changing the spectroscopic characteristic.

To achieve the above object, according to the present invention, there is provided a solid state imaging device including: color filters of three primary colors and their complementary colors, which are arranged on light receiving elements in a matrix; wherein those of said color filters, which are of one kind or two kinds of the three primary colors and their complementary colors, are composed of pigment based color filters, and the remaining color filters are composed of dye based color filters.

In the solid state imaging device of the present invention, of all color filters which have ordinarily been composed of either dye based or pigment based color filters, those of one kind or two kinds of colors especially being low in characteristics such as light resistance and thermal resistance are composed of pigment based color filters and the remaining color filters are composed of ordinary dye based color filters. As a result, according to the present invention, there can be realized the solid state imaging device having color filters being good in characteristics such as light resistance and thermal resistance without changing a spectroscopic characteristic so much, as compared with the related art solid state imaging device having color filters of all colors which are composed of dye based color filters.

### BRIEF DESCRIPTION OF THE DRAWINGS

FIG. 1 is a sectional view of a portion mainly including color filters, illustrating a process of producing a solid state imaging device having color filters according to the present invention; and

FIG. 2 is a diagram illustrating a color index of magenta used for the color filters of the solid state imaging device of the present invention.

### DETAILED DESCRIPTION OF THE PREFERRED EMBODIMENT

Hereinafter, one embodiment of the present invention will be described in detail with reference to the drawings.

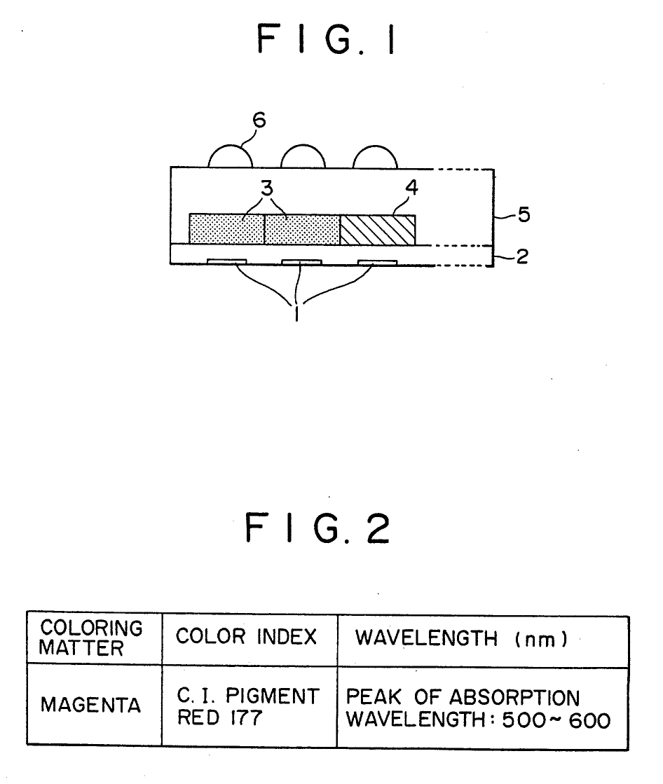

FIG. 1 is a sectional view of a portion mainly including color filters, illustrating a process of producing a solid state imaging device having color filters according to the present invention. Referring to FIG. 1, there will be described a configuration of the solid state imaging device of the present invention.

Color filters of the solid state imaging device of the present invention are produced, as shown in FIG. 1, by a manner of forming a planarization film 2 on sensor portions 1 formed on a semiconductor substrate, and forming color filters on the planarization film 2 at positions over the sensor portions 1. Specifically, as color filters of yellow (Y) and cyan (C), dye based color filters 3 are formed by the related art dying process including the known steps of patterning a material and dying the pattern.

On the other hand, as color filters of magenta (M) being low in light resistance and thermal resistance, pigment based color filters 4 are formed by a color resist process using a pigment based coloring matter. First, particles of a pigment based coloring matter are uniformly dispersed in a photosensitive composition, to prepare a colored photosensitive composition. In this embodiment, there is used a pigment based coloring matter having a color index of C. I. Pigment RED 177 (trade name) shown in FIG. 2. This coloring matter of magenta (M) has the peak of an absorption wavelength in a range of 500 to 600 nm.

The upper surface of the planarization film 2 formed on the sensor portions 1 is coated with a solution of a color resist colored by the above coloring matter of magenta (M). The color resist is pre-baked and patterned by exposure using an i-line type stepper, followed by development in a solution of sodium carbonate, to form raw filters of magenta (M). The raw filters thus formed are subjected to heat curing for preventing thermal deformation thereof and elution of the coloring matter, to thus obtain pigment based color filters 4. In addition, the above process is for illustrative purpose only, and the pigment based color filters 4 may be of course produced in accordance with a different process.

Upper surfaces of these dye based color filters 3 and the pigment based color filters 4 are coated with a lens material 5. The lens material 5 is patterned by photolithography and heat-treatment to form a lens pattern 6, followed by etching-back over the entire surface or the like, to thus form on-chip-lenses (not shown).

In this way, according to the solid state imaging device of the present invention, of all color filters of yellow (Y), cyan (C), and magenta (M) which have been ordinarily composed of either dye based or pigment based color filters, those of yellow (Y) and cyan (C) are composed of the dye based color filters 3 and those of magenta (M) are composed of the pigment based color filters 4 in consideration of the characteristics thereof. As a result, the color filters of the solid state imaging device of the present invention is allowed to significantly improve the characteristics such as light resistance and thermal resistance without changing the spectroscopic characteristic so much.

Specifically, according to the present invention, in consideration that the dye based color filters are high in resolution and spectroscopic characteristic but is low in characteristics such as light resistance and thermal resistance, of all colors filters which have been ordinarily composed of the dye based color filters 3, those of one kind or two kinds of the colors are composed of the pigment based color filters 4, so that the color filters of the present invention are superior in the characteristics such as light resistance and thermal resistance to the related art color filters all of which are composed of the dye based color filters 3 made from a pure natural organic matter.

Further, according to the present invention, all of the color filters are not made from the pigment based coloring matter, and therefore, there can be easily realized the color filters allowed to improve the characteristics such as light resistance and the thermal resistance without changing the spectroscopic characteristic so much.

While the preferred embodiment of the present invention is described using specific terms, the present invention is not limited thereto. For example, the present invention may be applied, in addition to the solid state imaging device described in the embodiment, to an AMI (Amplified MOS Intelligent Imager) device in which an amplifier circuit is formed in a pixel and a MOS type device. Also, there is no limitation to the structure of the solid state imaging device. In addition, the present invention can be of course applied to an image input/output device using color filters of three primary colors and their complementary colors.

What is claimed is:

1. A solid state imaging device comprising:
color filters of three primary colors or their complementary colors, which are arranged on light receiving elements in a matrix;
wherein those of said color filters, which are of one kind or two kinds of the three primary colors or their complementary colors, are composed of pigment based color filters, and the remaining color filters are composed of dye based color filters.

2. A solid state imaging device according to claim 1, wherein one kind of colors formed by said pigment based color filters is a complementary color, magenta, and the color index of a coloring matter used for said color filters of magenta is C. I. Pigment RED 177.

3. A solid state imaging device according to claim 1, wherein a color resist for forming said pigment based color filters comprises a positive type photosensitive resist.
